(19) United States
(12) Patent Application Publication
(10) Pub. No.: US 2014/0077753 A1
(43) Pub. Date: Mar. 20, 2014

(54) SUCTION-FIT SEPARABLE MOBILE BACKUP POWER SUPPLY

(71) Applicant: Meichan Wen, ShenZhen (CN)

(72) Inventor: Meichan Wen, ShenZhen (CN)

(21) Appl. No.: 13/995,001

(22) PCT Filed: Feb. 20, 2012
(86) PCT No.: PCT/CN2012/000214

§ 371 Date: Dec. 3, 2013

(51) Int. Cl. H02J 7/00

(52) U.S. Cl. CPC H02J 7/0054
USPC 320/103

(57) ABSTRACT

The power supply including the protection sleeve, power supply also including a battery charging module and engaging means, the battery charging module and engaging means is fixed, the engaging means is fixed with protection sleeve with fixed, the battery charging module includes a bottom cover and the bottom cover with isolation plate fixed, and a circuit board and a battery, the battery and circuit board connector, a cavity in the bottom cover, the battery and circuit board located in the cavity, the isolation plate is disposed above the circuit board and the battery, the circuit board provided with a terminal, top of the terminal with a terminal cover, the terminal cover the isolation plate fixed.

Since the protective sleeve and bottom cover is fixed, power while matching with mobile phone connected to terminal, on the one hand you can charge the phone from the power to extend the phone's standby time or use, Use the cable is not required to use any user-friendly, compact structure, small size, easy to carry user; Hand side protective sleeve and bottom but will be separated, user need to select personalized protective sleeve color.

### TECHNICAL FIELD

The invention relates to power technology field, especially relates to suction fit detachable phone power supply.

### BACKGROUND OF THE INVENTION

As technology advances, personal consumer electronics and more powerful features, such as smart phones, although it can provide people with more convenience and choice, smartphones although more powerful, but it needs to provide greater capacity batteries, otherwise the phone comes with a battery is easy to run out, can not provide sufficient long life, resulting in possible emergency rechargeable battery to charge the battery.

Current power source is usually separated from mobile phone, only will be connected to the power supply when using mobile phone, it will bring inconvenience to users. At the same time, the appearance of the smartphone to make more and more exquisite, electronic components has become increasingly sophisticated, its function is getting stronger and stronger. User during use to prevent scratches smart phone shell and reduce the impact force influence the reliability of smart phones, so smart phones usually smartphone needs to set up a case, because the smart phone cases do not have the power, and therefore not smart phones to charge their phone. Back at the same time, mobile power supply or future use power often cannot for smart phones, and in the use of mobile power source or standby back need through the cable connected with the power process, which brings convenience to use and carry.

### BRIEF SUMMARY OF EMBODIMENTS OF THE INVENTION

Technical problems solved by this invention is to provide suction fit detachable phone power supply, the power supply can provide a long time in power for communication terminal, extend the battery life of communication terminal, the power supply compact structure ,easy to use and carry.

In order to solve the above problem, the present invention provides suction fit detachable phone power supply, including the protection sleeve, power supply also including a battery charging module and engaging means, the battery charging module and engaging means is fixed, the engaging means is fixed with protection sleeve with fixed, the battery charging module includes a bottom cover and the bottom cover with isolation plate fixed, and a circuit board and a battery, the battery and circuit board connector, a cavity in the bottom cover, the battery and circuit board located in the cavity, the isolation plate is disposed above the circuit board and the battery, the circuit board provided with a terminal, top of the terminal with a terminal cover, the terminal cover the isolation plate fixed.

Preferably, the engaging means including two magnets, one magnets in protective sleeve, another magnet is provided in the battery charging module, two magnets positions correspond to each other.

Preferably, the engaging means including sucker, the sucker set in the battery charging module, the sucker and engaging means the protective cover fixed.

Preferably, on the circuit board also has a charging terminal and keys.

Preferably, The terminal cover has a translucent sheet, the terminal cover has a translucent sheet, the translucent sheet through the key handle contacts with key.

Preferably, the bottom cover with a through-hole, camera components with the through-hole.

The power supply including the protection sleeve, power supply also including a battery charging module and engaging means, the battery charging module and engaging means is fixed, the engaging means is fixed with protection sleeve with fixed, the battery charging module includes a bottom cover and the bottom cover with isolation plate fixed, and a circuit board and a battery, the battery and circuit board connector, a cavity in the bottom cover, the battery and circuit board located in the cavity, the isolation plate is disposed above the circuit board and the battery, the circuit board provided with a terminal, top of the terminal with a terminal cover, the terminal cover the isolation plate fixed.

Since the protective sleeve and bottom cover is fixed, power while matching with mobile phone connected to terminal, on the one hand you can charge the phone from the power to extend the phone's standby time or use, Use the cable is not required to use any user-friendly, compact structure, small size, easy to carry user; Hand side protective sleeve and bottom but will be separated, user need to select personalized protective sleeve color.

### BRIEF DESCRIPTION OF THE DRAWINGS

In order to more clearly illustrate embodiments of the invention or the prior art technical solutions, following the embodiments described in the prior art, or the accompanying drawings required for a brief introduction Apparently, while the description of the drawings is some embodiments of the invention, those of ordinary skill in the premise without creative efforts, you can also obtain other drawings based on these drawings.

FIG. 1 embodiment of the present invention the power supply breakdown structure diagram.

FIG. 2 is part of the structure A in FIG. 1 in an enlarged schematic view.

### DETAILED DESCRIPTION OF THE EMBODIMENTS OF THE INVENTION

To object of the invention to make technical solutions and advantages become more apparent, the following embodiments of the invention in conjunction with the accompanying drawings, embodiments of the present invention, the technical solutions clearly and completely described, obviously, the described embodiments are invention. part of the embodiments, but not all embodiments. Based on the embodiment of the present invention, persons of ordinary skill in the art without creative efforts obtained under the premise that all other embodiments, all belong to the protection scope of the present invention.

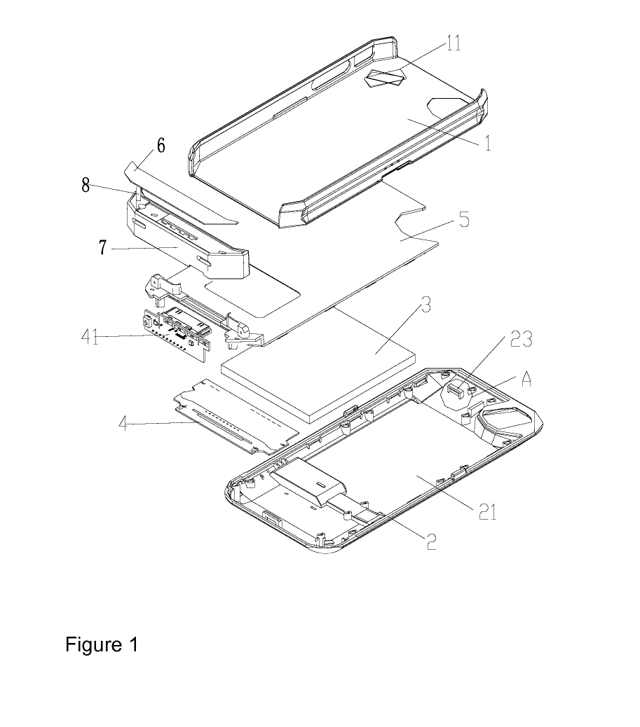

Shown in FIG. 1, the present invention provides the power supply embodiments.

The power supply, including the protection sleeve 1, power supply also including a battery charging module and engaging means, the battery charging module and engaging means is fixed, the engaging means is fixed with protection sleeve with fixed, the battery charging module includes a bottom cover 2 and the bottom cover 2 with isolation plate 5 fixed, and a circuit board 4 and a battery 3, the battery 3 and circuit board 4 connector, a cavity in the bottom cover 2, the battery 3 and circuit board 4 located in the cavity, the isolation plate 5 is disposed above the circuit board 4 and the battery 3, the circuit board 4 provided with a terminal 41, top of the terminal 41 with a terminal cover 7, the terminal cover 7 the isolation plate 5 fixed.

Specifically, on the circuit board 4 also has a charging terminal 41, keys and charging Interface, the terminals 41 can be user when the battery is not charging power can be. the keys on the phone can be operated via the buttons. The terminal cover 7 has a translucent sheet 6, the translucent sheet through the key handle contacts with key, the translucent sheet 6 can be used as a PVC sheet, the translucent sheet 6 by double-sided adhesive fixed with terminal cover 7. the translucent sheet 6 through better lighting the circuits board 4, user-friendly operation.

The engaging means including two magnets 11, one magnets 11 in protective sleeve 1, another magnet 11 is provided in the battery charging module, two magnets 11 positions correspond to each other.

Since the protective sleeve and bottom cover is fixed, power while matching with mobile phone connected to terminal, on the one hand you can charge the phone from the power to extend the phone's standby time or use, Use the cable is not required to use any user-friendly, compact structure, small size, easy to carry user; Hand side protective sleeve and bottom but will be separated, user need to select personalized protective sleeve color.

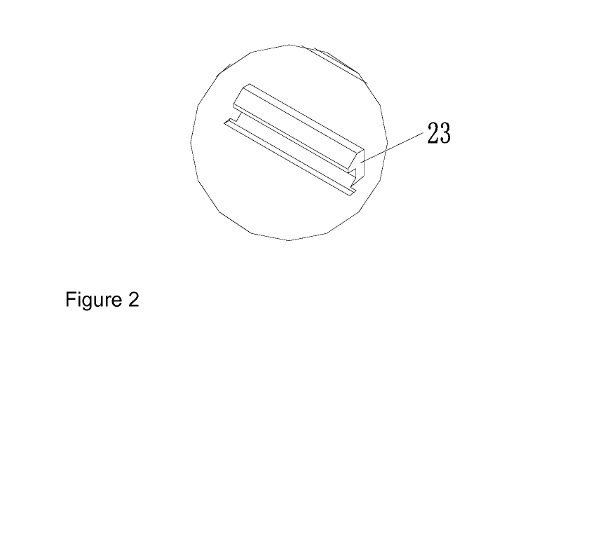

As shown in FIG. 2, the bottom cover is also a fixed buckle 23 can be well fixed battery, and can facilitate the assembly of the battery back-up back.

In the present embodiment, the bottom cover 2 with a through-hole 22, camera components 10 with the through-hole 22, for example camera lens. the through hole 22 during charging can take a photo.

The present invention also provides a engaging means, the engaging means including sucker Set on the battery charging module, The sucker pull the protective cover fixed.

Specifically, On the isolation plate is equipped with suction structure, for example, sucker, the sucker and pull protective sleeve fixed. And then the battery charging module with a fixed protective sleeve.

The above example is only technical solution to this invention, rather than on its limitations; Although refer to in the foregoing example has carried on the detailed description of this invention, the field of common technical personnel should understand: it can still for the foregoing cases recorded by the technical scheme, modified or equivalent replacement of some of these technical features which are modified or replaced, does not make the essence of the corresponding technical solution out of the present invention spirit and scope of technology solutions.

What is claimed is:

1. Suction fit detachable phone power supply, including the protection sleeve, power supply also including a battery charging module and engaging means, the battery charging module and engaging means is fixed, the engaging means is fixed with protection sleeve with fixed, the battery charging module includes a bottom cover and the bottom cover with isolation plate fixed, and a circuit board and a battery, the battery and circuit board connector, a cavity in the bottom cover, the battery and circuit board located in the cavity, the isolation plate is disposed above the circuit board and the battery, the circuit board provided with a terminal, top of the terminal with a terminal cover, the terminal cover the isolation plate fixed.

2. Suction fit detachable phone power supply of claim 1 wherein the engaging means including two magnets, one magnets in protective sleeve, another magnet is provided in the battery charging module, two magnets positions correspond to each other.

3. Suction fit detachable phone power supply of claim 1 wherein the engaging means including sucker, the sucker Set in the battery charging module, the sucker and engaging means the protective cover fixed.

4. Suction fit detachable phone power supply of claim 1 wherein on the circuit board also has a charging terminal and keys.

5. Suction fit detachable phone power supply of claim 4 wherein the terminal cover has a translucent sheet, the translucent sheet through the key handle contacts with key.

6. Suction fit detachable phone power supply of claim 5 wherein the bottom cover with a through-hole, camera components with the through-hole.
